(19) United States
(12) Patent Application Publication
(10) Pub. No.: US 2006/0211847 A1
(43) Pub. Date: Sep. 21, 2006

(54) Drive device

(76) Inventors: Frank-Uwe Sommer, Kirchheim (DE); Frank Sommer, Dettingen (DE)

Correspondence Address: VENABLE LLP, P.O. BOX 34385, WASHINGTON, DC, 20045-9998, US

(21) Appl. No.: 10/518,360

(22) PCT Filed: Jun. 5, 2003
(86) PCT No.: PCT/EP03/05901

§ 371 Date: Jul. 21, 2005

(30) Foreign Application Priority Data
Jun. 17, 2002 (DE) 102-27-110.0

(51) Int. Cl. H02K 7/14

(52) U.S. Cl. 530/350; 318/3

(57) ABSTRACT

The invention relates to a drive device, particularly for doors, garage doors, etc., comprising a guide device, particularly a rail or guide rail, extending in movement direction of the door. The invention is characterised in that the feed means comprises a first insert body which can be plugged at the ends of the guide rail into this and is provided with a connecting cable and which is held at the guide rail end and constructed in such a manner that it fulfils its function not only at one end of the guide rail, but also at the other end of the guide rail.

The invention relates to a drive device according to the introductory part of claim 1.

In known devices of this kind the feed means can be formed as a drag cable or consists of a connecting cable and current conducting rails which are connected therewith and guided parallel to the guide rails and at which the current for the electric motor is taken off. Moreover, it is also known to arrange a traction means longitudinally in the guide rail and retain it at the ends thereof as well as to use this chain as current feed means for an electric motor which runs along on a carriage at a guide rail. The traction means in that case obtains the drive current for the electric motor by way of a tightening device mounted at one end of the guide rail for the traction means. The operation with a drag cable is very disturbing for the user, whilst in the cases of the current rail feed and the current-conducting traction means the current feed is possible only from one end of the guide rail, in the vicinity of which the mains socket necessary for the current feed is arranged. If the drive current is to be fed from the other end of the guide rail because the socket lies in the vicinity thereof, then the current feed at the guide rail has to be changed in expensive manner, if not even two embodiments of the guide rail are needed and have to be kept in storage.

The object of the invention consists in creating a drive device of the kind stated in the introductory part of claim 1 which makes it possible to use one and the same type of guide rail for the current feed not only from one end, but also from the other end of the guide rail without having to take into account substantial conversion operations for this freedom of choice.

This object is met by the features of claim 1.

The drive device according to the invention has the advantage that the guide rail can be adapted to the location of the socket which is present by mere replugging of the first insert body.

According to a further construction of the invention a second insert body without connecting cable is provided at the guide rail ends and able to be plugged into these, the construction of the second insert body otherwise corresponding with that of the first insert body and the second insert body being arranged at that guide rail end lying opposite the guide rail end provided for the first insert body.

A further construction of the invention relates to a drive device in which the current feed means comprises the guide rail itself and a traction means, which is connected at a guide rail end with a connecting cable by way of a traction means tightening device. This construction is characterised by the fact that the first insert body carries a contact body contacting the guide rail. The otherwise usual clamping connection of one cable connecting wire with the guide rail is thus avoided.

According to a further construction of the invention the first or second insert body comprises a first part carrying the traction means tightening device and a second part forming an encircling abutment for the guide rail end. The traction means can therefore be mounted in simple manner.

According to a further construction of the invention the first part and the second part are integrally connected together. The insert body can therefore be produced as a simple plastics material injection-moulded part.

According to a further construction of the invention the second part has bores serving for the ceiling, wall and lintel fastening of the guide rail. The insert body at the same time serves as a support point for the fastening of the guide rail.

The invention is now explained in more detail by reference to an example of embodiment, wherein:

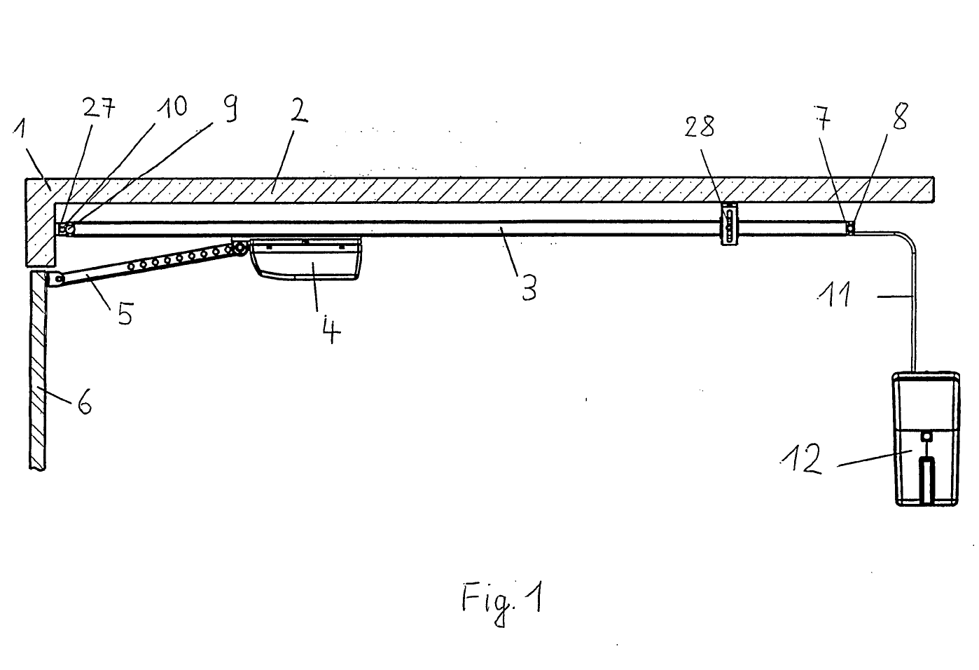

FIG. 1 shows a side view of a drive device according to the invention with a connection from the side remote from the door,

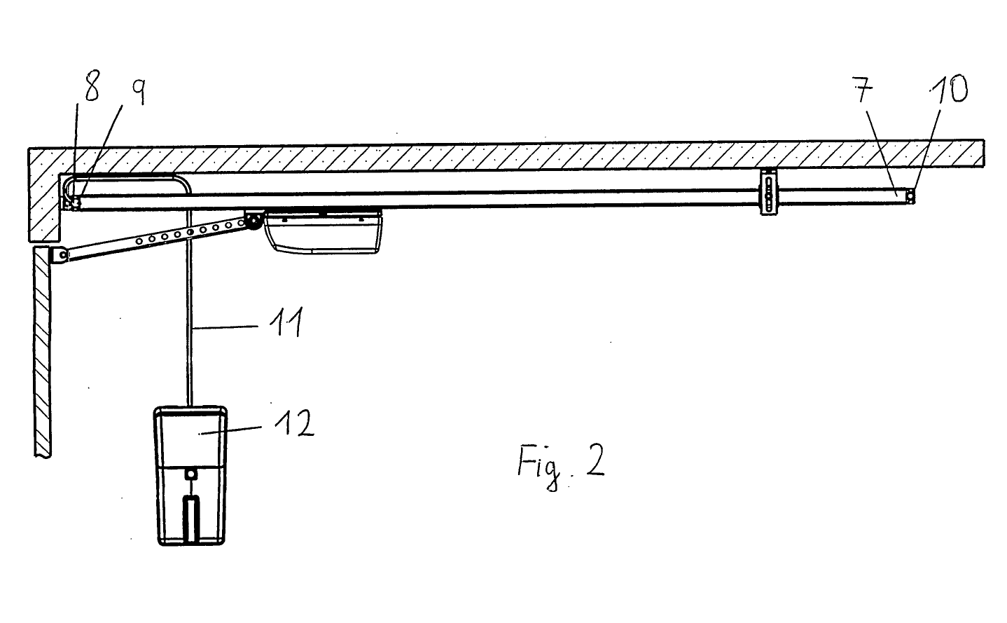

FIG. 2 shows a side view of a drive device according to the invention with a connection from the side facing the door,

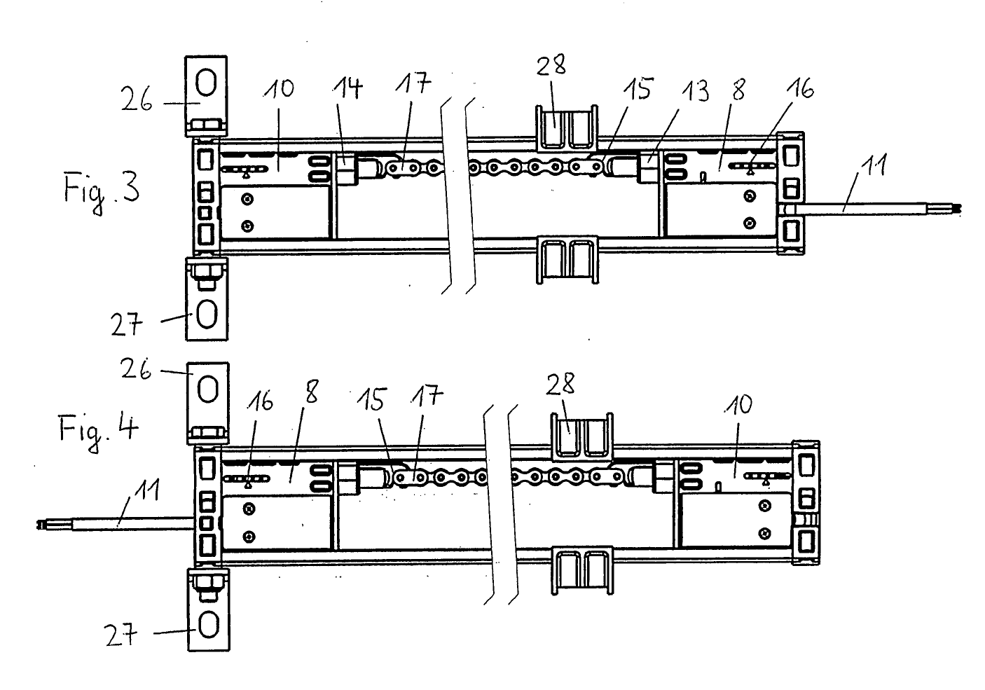

FIG. 3 shows an enlarged view of the guide rail, which is shown in FIG. 1, from below with insert bodies, connecting cable, traction means and rail fastening means,

FIG. 4 shows an enlarged view of the guide rail, which is shown in FIG. 2, from below with insert bodies, connecting cable, traction means and rail fastening means,

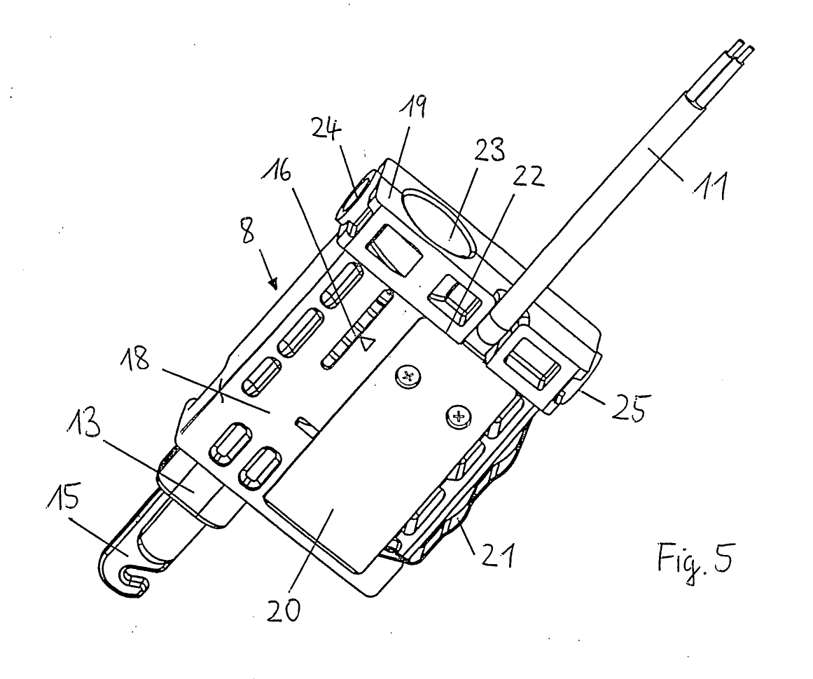

FIG. 5 shows an enlarged perspective view of a first insert body in use according to FIGS. 1, 3 and

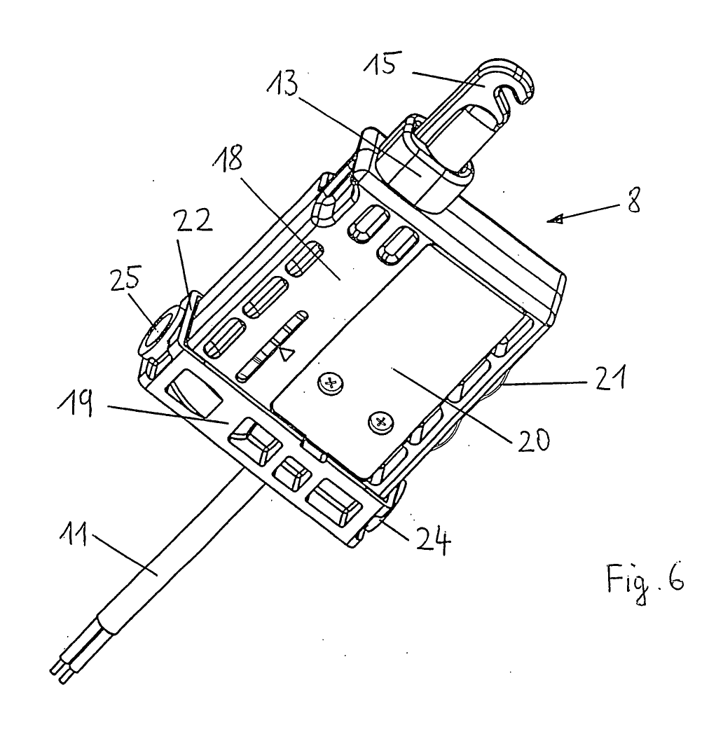

FIG. 6 shows an enlarged perspective view of a first insert body in use according to FIGS. 2, 4.

In FIG. 1 a part of a garage, namely a lintel 1 and a ceiling 2, is shown, to which a guide body—here a guide rail 3, preferably a rail which is C-shaped in cross-section, is fastened. A carriage 4 which is connected by way of a pivotably connected rod 5 with the door leaf 6 of the garage, runs at the guide rail. The end 7 of the guide rail 3 remote from the door leaf 6 is closed off by a first insert body 8 which can be plugged, whilst the end 9 of the guide rail 3 facing the door leaf 6 is closed off by a second insert body 10 which can be plugged. The first insert body 8 carries a current connecting cable 11 which opens at the other end into a control housing 12. The control housing 12 is plugged into a socket, which is not visible and which is arranged in the rearwardly disposed part of the garage.

In FIG. 2, which is similar to FIG. 1, the first insert body 8 and the second insert body 10 are interchanged after turning through an angle of 180°, so that now the end 9 is closed off by the first insert body 8 and the end 7 by the second insert body 10. In this case the control housing 12 is plugged into a socket, which is not visible and which is arranged in the forwardly disposed part of the garage.

In FIGS. 3 and 4 these two operating cases of FIGS. 1 and 2 are illustrated in more detail with respect to the guide rail 3, particularly profiled rails, wherein FIG. 3 is associated with FIG. 1 and FIG. 4 is associated with FIG. 2. In these figures the first insert body 8 has a traction means tightening device 13 and the second insert body 10 has a traction means tightening device 14, wherein these traction means tightening devices each comprise a respective hook or another part, which locks the traction means by mechanically positive couple, for example in bayonet-like manner, and allows tool-free fastening and detaching of the traction means without use of an additional traction means lock and which comprises an adjusting device adjusting the hook in rail longitudinal direction, as is shown, for example, in these FIGS. 3 and 4 by the hook 15 and the adjusting device 16. A traction means 17 is tightened between such hooks 16. The tightening device 13 and the traction means 17 are connected with a wire of the current feed cable 11. A gearwheel, which is not illustrated, of the electric motor arranged on the carriage 4 engages in the traction means 17, the drive winding of the electric motor thus obtaining current over the path covered.

The first insert body 8 is illustrated in more detail in FIG. 5. It consists of a substantially block-shaped body of two interconnected parts 18, 19 integrally produced from plastics material in the injection-moulding method.

The first part 18 carries the traction means tightening device 13 with the hook 15 and the adjusting device 16, a cover plate 20 also serving for retention relief of the current connecting cable 11 and, laterally, a contact 21 which is provided for the contacting of the other wire of the current connecting cable 11 with the guide rail 3, so that the drive winding of the electric motor is connected by its other pole with the connecting cable 11 over this path.

The second part 19 has a somewhat larger cross-section than the first part 18 and thus forms an encircling abutment 22 for retention of the plugged-in insert body 8 at the ends 7, 9 of the guide rail 3. The second part 19 has at the end face an opening 23 for access of the adjusting device 16 and, laterally, two bores 24, 25 which serve for fastening of the guide rail 3 to the lintel 1 (see FIG. 1). As FIGS. 3 and 4 show, this fastening can be carried out by means of brackets 26, 27. A further fastening point of the guide rail 3 is a bracket 28, which is fastened to the garage ceiling 2.

FIG. 6 shows the turned first insert body 8 at which the abutment 22 can be clearly recognised.

The second insert body 10 is preferably constructed just as the first insert body 8, but the connecting cable 11 is absent at it. In addition, the cover plate 20 and the contact 21 can be absent. Stock-keeping can therefore be confined to a single type of the insert body. In the case of change of the first insert body 8, the second insert body 10 is exchanged therewith.

1. A drive device for a door, comprising:
a guide device, comprising a rail, extending in a movement direction of the door;
a carriage to move along said guide device and comprising an electric motor, to cause movement of a door leaf, and further comprising a current feed connecting the electric motor with a current source, the current of which is supplied at one end of the guide device,
wherein said current feed comprises a first insert body to be plugged into an end of the guide device and a connecting cable, said current feed being arranged to be capable of being used at either end of said guide device.

2. The drive device according to claim 1, further comprising:
a second insert body without a connecting cable, said second insert body having a form corresponding to that of said first insert body so as to be plugged into an end of the guide device into which said first insert body is not plugged.

3. The drive device according to claim 1, wherein the current feed means comprises said rail and a traction means, the traction means to be connected at one end of said rail with a connecting cable using a traction means tightening device,
and wherein the first insert body further comprises a contact body to contact said rail.

4. The drive device according to claim 3, wherein at least one of the group consisting of the first insert body and the second insert body comprises:
a first part to carry the traction means tightening device; and
a second part to provide an encircling abutment (22) for an end of said rail.

5. The drive device according to claim 4, wherein the first part and the second part are integrally connected together.

6. The drive device according to claim 4, the second part has bores to be used for fastening said rail.

7. A drive device for a door, comprising:
a guide device extending in a movement direction of the door and having two ends;
a carriage that moves along the guide device and comprising an electric motor for causing movement of a door leaf, further comprising a current feed to connect the electric motor with a current source, wherein the current feed comprises a traction mechanism and a first insert body to be plugged into the guide device, wherein the first insert body includes a traction mechanism tensioning device with a positive interlocking part to lock in place the traction mechanism.

8. The drive device according to claim 7, wherein the first insert body is to be inserted optionally into either end of the guide device.

9. The drive device according to claim 8, further comprising a second insert body having a traction mechanism tensioning device with a positive interlocking part to lock into place the traction mechanism.

10. The drive device according to claim 9, wherein the traction mechanism is tensioned between the traction mechanism tensioning devices of the first and second insert bodies at the ends of the guide device.

11. The drive device according to claim 7, wherein the traction mechanism comprises a chain.

12. The drive device according to claim 7, wherein the positive interlocking part for at least one of the traction mechanism tensioning devices is bayonet shaped.

13. The drive device according to claim 7, wherein the positive interlocking part of at least one of the traction mechanism tensioning means comprises a hook.

14. The drive device according to claim 7, wherein the guide device comprises a guide rail that forms a component of the current feed.

15. The drive device according to claim 14, wherein at least one of said first and second insert bodies comprises:
a first part to carry the traction mechanism tensioning device; and
a second part to form an end stop at an end of the guide rail, the second part having an opening to permit accessing an adjustment device of the traction mechanism tensioning device.

16. The drive device according to claim 15, wherein said adjustment device enables the positive interlocking part of the traction mechanism tensioning device to be adjusted in a longitudinal direction of the guide rail.

17. The drive device according to claim 14, wherein the first insert body further comprises:
a connecting cable; and
one or more contact elements to make contact with the guide rail.

18. The drive device according to claim 17, wherein the traction mechanism tensioning device and the traction mechanism are connected to a first lead of the connecting cable.

19. The drive device according to claim 17, the first insert body further comprising a cover plate to provide traction relief for the connecting cable.

20. The drive device according to claim 17, wherein at least one said contact element is connected to a second lead of the connecting cable.
